(19) United States
(12) Patent Application Publication
(10) Pub. No.: US 2010/0085338 A1
(43) Pub. Date: Apr. 8, 2010

(54) IMAGE DISPLAY DEVICE

(75) Inventor: Mitsuaki Miguchi, Kyoto (JP)

Correspondence Address: FISH & RICHARDSON P.C., P.O. BOX 1022, MINNEAPOLIS, MN, 55440-1022, US

(73) Assignee: Rohm Co., Ltd., Kyoto (JP)

(21) Appl. No.: 12/067,064

(22) PCT Filed: Oct. 12, 2006
(86) PCT No.: PCT/JP2006/320404

§ 371 Date: Mar. 17, 2008

(30) Foreign Application Priority Data
Oct. 13, 2005 (JP) 2005-298508

(51) Int. Cl. G09G 5/00

(52) U.S. Cl. 345/207

(57) ABSTRACT

An image display device of the present invention adopts a field sequential method whereby image display is performed by sequentially lighting light emitting devices in a backlight portion for each field. The image display device includes: a brightness sensor that is arranged so as to face the backlight portion with a display panel sandwiched in between and detects the brightness of light emitted from the backlight unit and transmitted through the display panel for each of light emitting colors; or a brightness sensor that detects the brightness of the light from the backlight portion for each of the emission colors and detects, by a common light receiving section, the brightness irrespective of the emission colors. The brightness of the light of the backlight portion is controlled according to the detected brightness value for each of the emission colors. This enables constant white balance adjustment to be achieved while realizing accurate detection of brightness required for the white balance adjustment.

### TECHNICAL FIELD

The present invention relates to an image display device adopting a field sequential method.

### BACKGROUND ART

In recent years, image display devices using a field sequential method (which is also referred to as “FS method” hereinafter) have been developed. According to the FS method, as a backlight unit for illuminating a display panel from behind, one having (red, green, and blue) LEDs (light emitting diodes) as a light source is provided, and image display is performed by turning on the LEDs in turn on a time-division basis. This method requires no color filter, and thus offers the advantages of reduced fabrication cost and satisfactory brightness. Hereinafter, each of the time intervals at which time division takes place is also referred to as “field”.

On the disadvantageous side, due to various factors such as the tendency of light emitting devices for example LEDs of different emission colors to require different currents to produce equal brightness, and the fact that each individual light emitting devices emits a different amount of light, white balance adjustment is particularly important in image display devices using the FS method. Accordingly, in the development of image display devices using the FS method, various methods of white balance adjustment have been studied.

For example, in Patent Publication 1, a conventional method is described according to which, in a light source, light-detecting devices are provided one for each of LEDs of different colors, and according to the amounts of light detected by these light-detecting devices, the periods during which to light the LEDs are controlled, so that white balance adjustment is carried out constantly. By constantly adjusting white balance in this way, it is possible to cope with changes in the light emitting properties of the LEDs with time or with temperature.

### Patent Publication 1: JP-A-2004-86081

### DISCLOSURE OF THE INVENTION

### Problems to be Solved by the Invention

Inconveniently, however, in the conventional example described above, since the light-detecting devices (brightness sensors) for detecting the amounts of light from the individual LEDs are provided on the light source side of the liquid crystal panel, the accuracy of brightness detection suffers in the following respect.

The brightness detected by light-detecting devices placed on the light source side of the liquid crystal panel is different from the brightness of the light that has passed through the liquid crystal panel (i.e., the light that the user actually observes). In addition, the light from LEDs of different emission colors passes through the panel at different transmittances. With these facts taken into consideration together, detecting the brightness of light before it passes through the liquid crystal panel may lead to lower detection accuracy.

Furthermore, since the light-detecting devices are provided one for each of the LEDs and are different from one another in sensitivity, there may be variations among the values detected by the light-detecting devices. In this respect also, brightness detection accuracy may suffer. In the first place, the more light-detecting devices are provided, the less easy it is to make products compact and inexpensive, and thus the less advisable.

From the perspective of brightness control, controlling the apparent brightness of LEDs by varying the periods for which they are lit as in the conventional example is difficult to practice in cases where the LEDs are turned on and off repeatedly at short time intervals. In particular, in an image display device using the FS method, since LEDs of different colors need to be turned on and off repeatedly at a frequency of 60 Hz to 100 Hz or more, it is difficult to control the periods for which the LEDs are lit.

An object of the present invention is to provide an image display device that constantly adjusts white balance and yet can achieve, with high accuracy, brightness detection necessary for white balance adjustment. Another object of the present invention is to facilitate the control of brightness by the FS method.

### Means for Solving the Problem

To achieve the above object, according to one aspect of the present invention, an image display device includes: a backlight portion having as a light source a plurality of light emitting devices of different emission colors; a display panel displaying an image by adjusting transmittances at which the display panel transmits light from the backlight portion; and a control section controlling brightness of the light of the backlight portion, the image display device adopting a field sequential method whereby the image is displayed as a result of the light emitting devices being lit in turn, one for each field. Here, the image display device further comprises brightness sensors arranged to face the backlight portion with the display panel in between, the brightness sensors detecting, one for each of the emission colors, brightness of the light emitted from the backlight portion and transmitted through the display panel, and the control section controls, for each of the emission colors independently, the brightness of the light of the backlight portion according to values of the detected brightness (first configuration).

With this configuration, the brightness of the light of the backlight portion is controlled according to the data detected by the brightness sensors. As a result, a real-time brightness adjustment (e.g., white balance adjustment) can be constantly performed. This makes it possible to advantageously cope with changes in the light emitting properties of the LEDs with time or with temperature.

In addition to this advantage, since the brightness sensor detects the brightness of the light emitted from the backlight portion and transmitted through the display panel, it can detect the brightness of the light that the user actually observes, and thereby can perform highly accurate brightness detection. That is, in the case where brightness is detected at a position on the light source side of the liquid crystal panel, a complex control is required due to the need for the correction of the transmittance at which light is transmitted through the panel. This makes detection errors more likely to occur. In contrast, however, with the first configuration, such a problem does not arise.

According to the present invention, in the first configuration described above, in a part of the display panel, a detection window may be formed through which the light is transmitted at fixed transmittances in no matter which field, and the brightness sensors may detect the brightness of the light transmitted through the detection window (second configuration).

With this configuration, since the brightness sensors detect the brightness of the light transmitted through the predetermined detection window, it can detect the brightness of the light from the backlight portion with equal accuracy, in no matter which field (i.e., for no matter which emission color). This eliminates the need for considering, with respect to the data detected by the brightness sensors, the differences in transmittance among the emission colors.

According to another aspect of the present invention, an image display device includes: a backlight portion having as a light source a plurality of light emitting devices of different emission colors; a display panel displaying an image by adjusting transmittances at which the display panel transmits light from the backlight portion; and a control section controlling brightness of the light of the backlight portion, the image display device adopting a field sequential method whereby an image is displayed as a result of the light emitting devices being lit in turn, for each field. Here, the image display device further comprises a brightness sensor detecting the brightness of the light from the backlight portion for each of the emission colors independently and sensing the brightness with a light-receiving portion shared for the different emission colors, and the control section controls, for each of the emission colors independently, the brightness of the light of the backlight portion according to values of the detected brightness (third configuration).

With this configuration, since the brightness of the light from the backlight portion is detected by the shared light-receiving portion for whichever emission color, there is no need for taking into consideration differences in sensitivity among the plurality of light-receiving portions. This makes it possible to perform accurate brightness detection without correcting the variations in sensitivity among the light-receiving portions. Furthermore, since the number of light-receiving portions can be reduced as compared with in the case where light-receiving portions are provided one for each emission color. This makes it possible to make the brightness sensor compact, and thereby to produce products inexpensively.

According to the present invention, in the first or second configuration described above, the brightness sensor senses the brightness with a shared light-receiving portion for no matter which emission color (fourth configuration).

With this configuration, since the brightness sensor detects the brightness of the light emitted from the backlight portion and transmitted through the display panel, it can detect the brightness of the light that the user actually observes, and furthermore, since the brightness for each of the emission colors is detected by the shared light-receiving portion, there is no need for taking into consideration the variation in sensitivity among different light-receiving portions. Thus, the combination of the advantages of the first and third configurations helps further improve the accuracy with which brightness is detected.

According to the present invention, the first or the second configuration described above may further include a calculation section calculating, for each of the emission colors independently, a difference between a value of the detected brightness and a value of a predetermined target brightness, and the control section may control the brightness of the light of the backlight portion so as to minimize an absolute value of the difference (fifth configuration). In this way, the brightness of the light from the backlight portion is controlled so as to approach the value of the target brightness. If a value of the brightness with which ideal white balance can be achieved is adopted as the target value of brightness, adjustment is performed so as to achieve the ideal white balance.

According to the present invention, in the first or the second configuration described above, the light emitting devices may emit light having brightness corresponding to amounts of current supplied respectively thereto, and the control section may control the brightness of the light from the backlight portion by controlling the amounts of current supplied to the light emitting devices. (sixth configuration).

With this configuration, since the brightness itself of light emitting devices is controlled by controlling the amounts of current supplied respectively thereto, the control does not require the changing of the periods during which the individual light emitting devices are lit. As a result, the brightness can be adjusted comparatively easily even when the FS method is used whereby the light emitting devices are repeatedly turned on and off in turn at very short time intervals.

According to another aspect of the present invention, the control section controls the amount of current by a PWM method and/or with a variable constant current circuit (seventh configuration). In this way, the sixth configuration described above can be achieved quite easily.

### Advantages of the Invention

As described above, with the image display device of the present invention, adjustment of the brightness of the light of the backlight portion (e.g., white balance adjustment) can be constantly performed, and this makes it possible to cope with the change in the light emitting properties of the LEDs with time or with temperature. In addition, the brightness sensor can detect the brightness of the light that the user actually observes, and this makes it possible to adjust white balance easily with high accurately. That is, a complex control is required due to the need for the correction of the transmittance at which light passes through the panel, if brightness is detected at a position on the light source side of the liquid crystal panel, and this makes detection errors more likely to occur; with the image display device of the present invention, however, no such problem arises.

### BRIEF DESCRIPTION OF DRAWINGS

FIG. 1 A diagram showing an appearance of an embodiment of the present invention.

FIG. 2 A diagram showing the overall structure of the embodiment of the present invention.

FIG. 3 A diagram showing a first example of the configuration of a current control section in the embodiment of the present invention.

FIG. 4 A diagram showing a second example of the configuration of a current control section in the embodiment of the present invention.

FIG. 5 A flow chart of the brightness correction process in the embodiment of the present invention.

### LIST OF REFERENCE SYMBOLS

10 current control section (control section)
11 light emission pattern generator
12R, 12G, 12B constant current circuits
13R, 13G, 13B switches
14 oscillator
15R, 15G, 15B voltage comparators
16R, 16G, 16B AND gates
17R, 17G, 17B variable constant current circuits
20 backlight unit (backlight portion)
21R, 21G, 21B LEDs (light emitting devices)
22 voltage source
23 light guide plate
30 liquid crystal display panel (display panel)
31 detection window
40 brightness detecting section
41 brightness sensor
42 switch section
50 calculation section
60 setting section

### BEST MODE FOR CARRYING OUT THE INVENTION

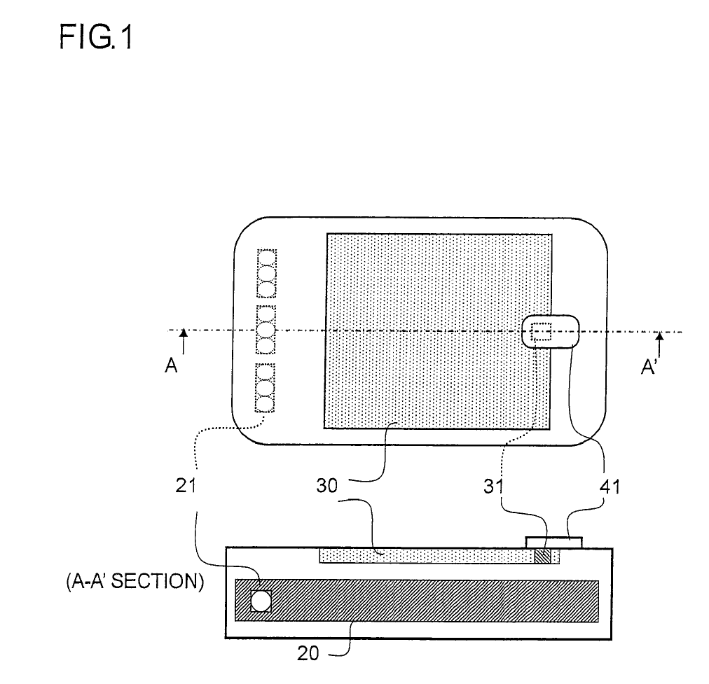

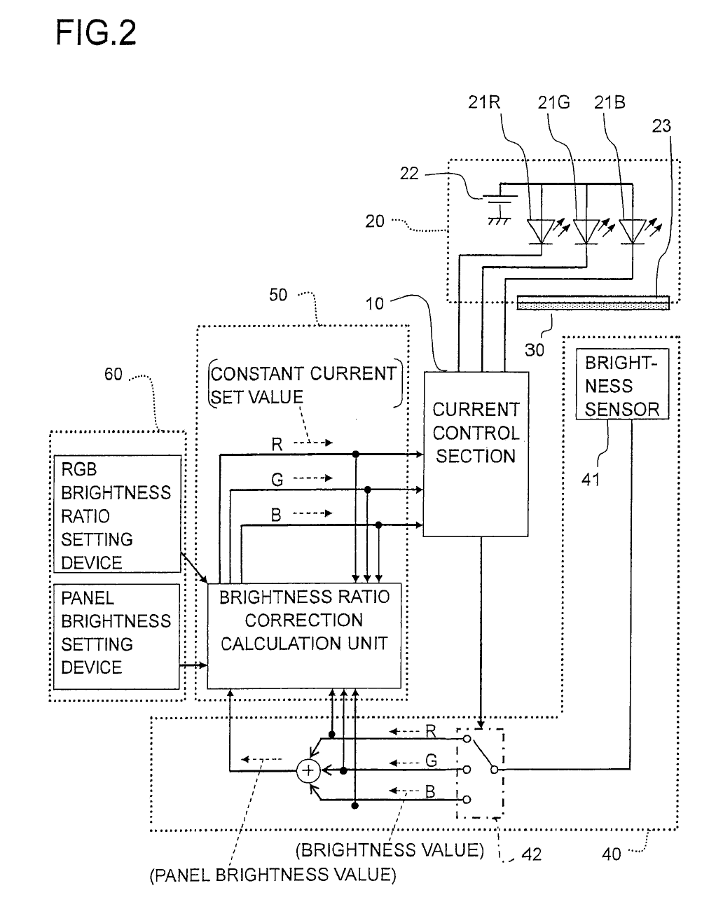

The following description will deal with, as an embodiment of the present invention, a portable liquid crystal display device adopting the field-sequential method. FIG. 1 shows the appearance of the device. As shown in the figure, a liquid crystal panel 30 is disposed at the top face side of a backlight unit 20, and a brightness sensor 41 that senses the light from the backlight unit 20 is disposed in a predetermined position. FIG. 2 shows the overall structure of the device. As shown in FIG. 2, the device includes a current control section 10, the backlight unit 20, the liquid crystal panel 30, a brightness detecting section 40, a calculation section 50, a setting section 60, etc.

The current control section 10 supplies LEDs 21R, 21G, and 21B with predetermined amounts of current based on the result of the calculation by the calculation section 50, and thereby controls the brightness of each of the LEDs. The configuration of the current control section 10 will be described in detail later.

The backlight unit 20 is composed of the LEDs 21R, 21G, and 21B emitting RGB (red, green, and blue) light respectively, a voltage source 22 that applies voltages to these LEDs, a light guide plate 23, etc. This permits the LEDs 21R, 21G, and 21B to emit RGB light, respectively, at brightness corresponding to the amounts of current supplied thereto from the current control section 10. The light is led to the liquid crystal panel 30 by the light guide plate 23. Two or more of each of the LEDs 21R, 21G, and 21B may be provided, and the voltage source 22 may be built as a switching power supply incorporating a switching device such as a switching regulator and a charge pump.

The liquid crystal panel 30 is composed of two substrates disposed so as to face each other with a liquid crystal layer laid in between, electrodes disposed on the substrates to form pixels, a driver that supplies the electrodes with a predetermined amount of electric charge, TFTs (thin film transistors) that serve as switching devices, and the like. With this configuration, the optical rotary power of the liquid crystal is controlled with the voltages applied between the pixel electrodes, and thereby the transmittance at which the light from the backlight unit is transmitted through the liquid crystal panel is controlled so that a desired image is displayed.

In a peripheral part of the liquid crystal panel 30, a detection window 31 (see FIG. 1) is formed through which the brightness sensor 41 detects light from the backlight unit 20. The part of the liquid crystal panel 30 where the detection window 31 is formed has the same configuration as the other part of the liquid crystal panel 30 except that it is so controlled as to transmit light at a fixed transmittance in no matter which field. Specifically, in this part, the voltage between the pixel electrodes is controlled to remain constant so that the optical rotary power of the liquid crystal remains constant, and thus the transmittance remains constant. Accordingly, in the detection window 31, the light from the backlight unit 20 is transmitted at an equal transmittance no matter what is displayed or no matter in what emission color.

The brightness detecting section 40 is composed of the brightness sensor 41 that generates an electric signal (detected brightness data) corresponding to the brightness of the light it receives, a switch section 42 that feeds the calculation section 50 with the detected brightness data for each of R, G, and B by operating a switch for each field, etc.

The brightness sensor 41 is so arranged as to face the backlight unit 20 with the liquid crystal display panel laid in between. The brightness sensor 41 detects the brightness of the light emitted from the backlight unit 20 and transmitted through the liquid crystal display panel, and then outputs the detected brightness data on it.

Here, in this display device adopting the FS method, the LEDs 21R, 21G, and 21B are each lit independently, one in each field; and the light emission pattern generator 11 keeps track of what is the color of the LED currently lit. Thus, the brightness sensor 41 does not need to detect the chromaticity of the light it receives, but only needs to detect the brightness of the light. Accordingly, the brightness sensor 41 is provided with a single shared light-receiving portion for sensing the brightness of the light of any of R, G, and B, and this single shared light-receiving portion senses the brightness of the light from the backlight unit 20, for whichever emission color. Although the brightness sensor 41 is disposed in one position in this embodiment, a plurality of brightness sensors 41 may be disposed in a plurality of positions and the mean value of the values detected by these brightness sensors 41 may be adopted when, for example, a large screen is used.

In contrast to the case where a plurality of light-receiving portions are provided and used for different emission colors, in the case where the brightness sensor 41 is provided with a single light-receiving portion commonly used for each of the emission colors as described above, there is no need for taking into consideration differences in sensitivity among a plurality of light-receiving portions. As a result, the brightness of the light from the backlight unit 20 can be detected with high accuracy without correcting variations in sensitivity. Furthermore, as brightness sensors each have less light-receiving portions, they can accordingly be made compact and produced inexpensively. Since the configuration of a sensor that can detect the brightness of light of different colors by using a single shared light-receiving portion is well known, no detailed description thereof will be given.

Moreover, the brightness sensor 41 is disposed in a position corresponding to the position where the detection window 31 mentioned above is formed, and receives the light emitted from the backlight unit 20 and transmitted through the detection window 31. Thus, the brightness sensor 41 can accurately detect brightness for no matter what emission color.

It is preferable to arrange the brightness sensor 41 so as to face the backlight unit 20 with the liquid crystal display panel laid in between as described above, because then the brightness of the light transmitted through the display panel is detected, that is, the brightness of the light that the user actually observes is detected, and thus the brightness can be detected with high accuracy. Instead, though with lower detection accuracy, the brightness sensor 41 may be arranged near the backlight unit 20 (i.e., so as not to face the backlight unit 20 with the liquid crystal display panel laid in between); even then, by multiplying the value of the detected brightness by a certain proportionality constant (corresponding to the transmittance at which the light is transmitted through the liquid crystal display panel), it is possible to obtain a value that is close to the brightness of the light transmitted through the liquid crystal panel (the brightness of the light that the user actually observes).

The switch section 42, according to a signal from the light emission pattern generator 11, operates the switch according to the color of the light that is currently being emitted. For example, when the red LED is on, the switch is operated so that the detection signal is fed to the R input terminal of the calculation section.

The calculation section 50 compares the detected brightness data for each of the emission colors received from the brightness detecting section 40 with the target value of the brightness of the light for each of the emission colors calculated based on the data set by the setting section 60 (target brightness value), and calculates the amount by which to correct the brightness for each of the emission colors. Then, the calculation section 50 feeds the obtained data of the correction amount to the current control section 10. The calculation will be specifically described later.

At the setting section 60, a target value of the RGB brightness ratio (which gives the desired white valance) and a target value of the panel brightness (mean brightness of RGB) are set and stored in the memory beforehand.

Having the configuration described above, the liquid crystal display device of this embodiment performs image display by using the method whereby red, green, and blue LEDs are lit in turn, one in each field, that is, by the field sequential method, while constantly adjusting white balance through brightness correction.

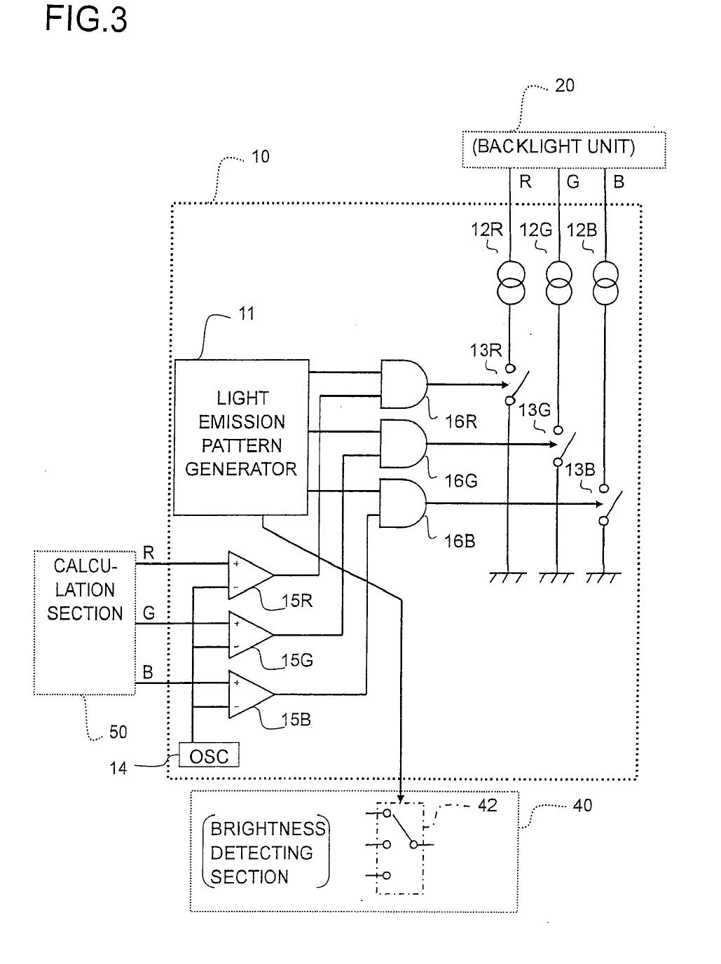

Next, an example (a first example) of the configuration of the current control section 10 mentioned above is shown in FIG. 3. As shown in FIG. 3, the current control section 10 is composed of the light emission pattern generator 11, constant current circuits 12R, 12G, and 12B, switches 13R, 13G, and 13B, an oscillator 14, voltage comparators 15R, 15G, and 15B, AND gates 16R, 16G, and 16B, etc. The letters R, G, or B suffixed a reference numeral indicates the color (red, green, or blue) concerned.

The light emission pattern generator 11 makes the individual LEDs emit light and stop emitting light according to the data stored in an unillustrated memory or according to data fed from outside. The light emission pattern generator 11 generates light emission control signals corresponding to the different emission colors; when a given light emission control signal is at a high level, the corresponding LED emits light; when a given light emission control signal is at a low level, the corresponding LED does not emit light. In this display device adopting the FS method, for the purpose of making the LEDs emit light in turn in order of red, green, and blue, on a time-division basis, the light emission control signals for the different emission colors are turned high in turn. Any one of the light emission control signals turns high at a period corresponding to 210 Hz so that the LED of each color emits light at a period corresponding to 70 Hz.

The constant current circuits 12R, 12G, and 12B are connected to the cathode terminals of the LEDs 21R, 21G, and 21B in the backlight unit 20, respectively, and are provided in the current paths for the individual LEDs. The constant current circuits 12R, 12G, and 12B each make the LEDs 21R, 21G, and 21B emit light by permitting predetermined amounts of current to flow through them when the switches 13R, 13G, and 13B are on.

The switches 13R, 13G, and 13B turn on and off the current generating operation by the constant current circuits 12R, 12G, and 12B. The switches 13R, 13G, and 13B are controlled by the output signals of the AND gates 16R, 16G, and 16B, respectively, such that they are turned on when the output signals of the corresponding AND gates 16R, 16G, and 16B are high, and they are turned off when the output signals of the corresponding AND gates 16R, 16G, and 16B are low. In this way, the duty ratios of the currents supplied to the LEDs 21R, 21G, and 21B are adjusted.

The oscillator 14 generates a periodic voltage having a triangular or a sawtooth-shaped waveform. The oscillating frequency of the oscillator 14 is set significantly higher than the frequency of the light emission control signal described above.

The voltage comparators 15R, 15G, and 15B each receive the periodic voltage outputted from the oscillator and a brightness correction voltage; the voltage comparators each output a high-level signal when the brightness correction voltage is higher than the periodic voltage, and output a low-level signal when the brightness correction voltage is lower than the periodic voltage. Here, the brightness correction voltage is a voltage that an unillustrated voltage generator generates according to the data of the amount of brightness correction that the calculation section 50 calculates. As a result, the voltage comparators 15R, 15G, and 15B each output a PWM (pulse width modulation) signal corresponding to the data of the amount of brightness correction.

The AND gates 16R, 16G, and 16B each receive the light emission control signal from the light emission pattern generator 11 and the PWM signal from the voltage comparators 15R, 15G, and 15B, and outputs the AND of these signals to open/close the switches 13R, 13G, and 13B. In this way, the opening and closing of the switches 13R, 13G, and 13B corresponding to the pulse of the PWM signal is achieved with respect to the color of which the light emission control signal is high.

Having the configuration described above, the constant current control section 10 supplies currents to the LEDs of the different colors on a time-division basis, and the amount of brightness correction calculated by the calculation section 50 is reflected in the amount of current. That is, the amounts of current supplied to the LEDs are controlled by a PWM method based on the result of the calculation by the calculation section 50.

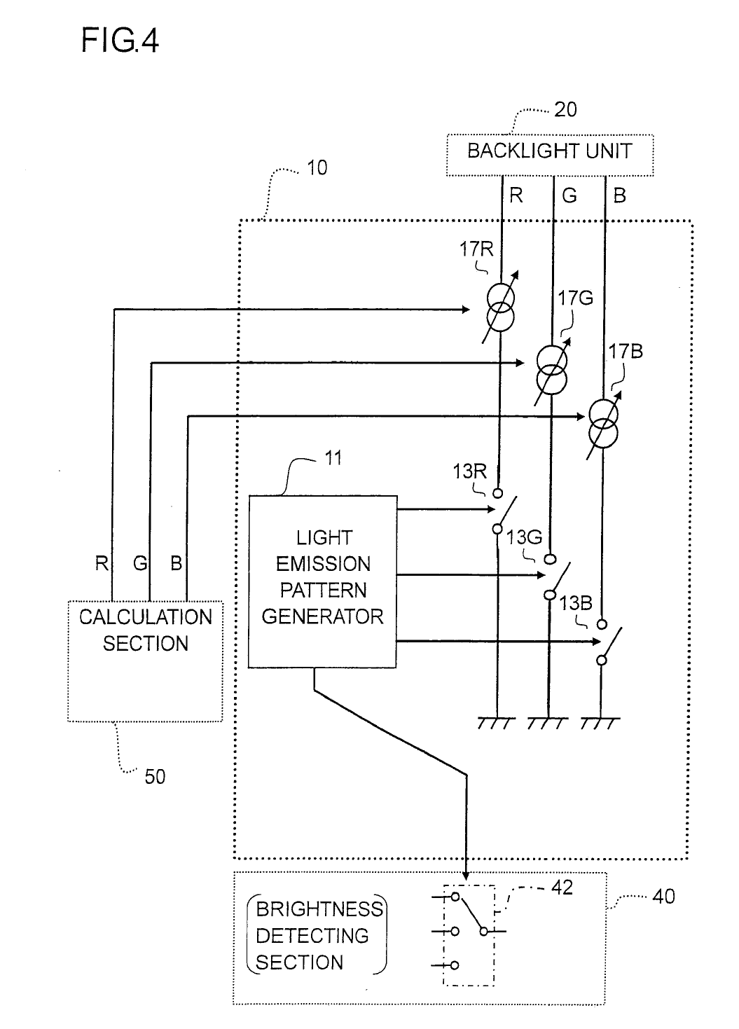

The current control section 10 may be configured as shown in FIG. 4 (a second example of the configuration). Here, in contrast to the first example of the configuration where the amount of current is controlled by the PWM method, the amount of current is adjusted by variable constant current circuits 17R, 17G, and 17B. That is, instead of adjusting the duty ratio of the current, the variable constant current circuits 17R, 17G, and 17B adjust the steady-state value itself of the current.

Incidentally, the control by the PWM method described in the first example of the configuration and that by controlling the steady-state value itself of the current described in the second example of the configuration are not necessarily incompatible with each other. For example, it is possible to make the steady-state value of the current variable so as to roughly control the amount of current while finely controlling the amount of current by the PWM method.

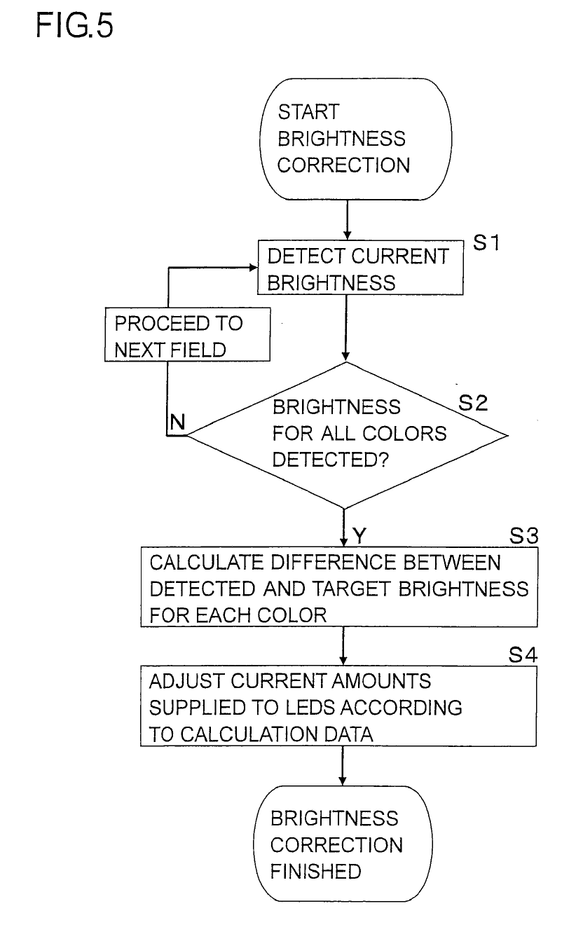

Next, the flow of the brightness correction in this embodiment will be described with reference to FIG. 5. While any one of the red, green, and blue LEDs is on with a current supplied thereto from the current control section 10, a detection signal (current) corresponding to the brightness of the light from the backlight unit 20 arises in the brightness sensor 41. The detection signal is, via the switch section 42, supplied to an input terminal of the calculation section 50 corresponding to the color of the diode which is currently on and emitting light. In this way, the current brightness of the light from the backlight unit 20 is detected (step S1).

Then, each time the brightness of the light from the backlight unit 20 is detected, it is checked whether or not the brightness for all of red, green, and blue has been detected (step S2). If the brightness for any of the colors has not been detected, the same operation is repeated in the next field. That is, the above-described operation is repeated until the data of the brightness has been detected for all of red, green, and blue.

When the data of the brightness for all of red, green, and blue has been obtained, the calculation section 50 calculates the difference between the value of the detected brightness (detected brightness value) and the value of the brightness that is to be aimed at by the adjustment (target brightness value) with respect to each of the emission colors, and feeds the calculation data to the current control section 10. The target brightness value for each emission color is obtained according to the data stored beforehand in the setting section 60.

Then, the current control section 10, according to the calculation data, adjusts the amounts of current supplied to the LEDs 21R, 21G, and 21B so as to minimize the absolute value of calculated value (the difference between the detected brightness value and the target brightness value) (step S4). More specifically, the current control section 10 increases the amount of current when the detected value is larger than the target value, and decreases the amount of current when the detected value is smaller than the target value. The adjustment of the amount of current is achieved, for example, by gradually changing the amount of current until the detected brightness becomes equal to the target brightness.

The brightness correction process described above is regularly performed while the image display device is in operation, and when to carry out the process can be set freely. Thus, constant adjustment of white balance can be achieved, and this makes it possible to cope with changes in the light-emitting properties of the LEDs with time or with temperature.

The brightness of an LED may be affected by factors such as the temperature of the LED itself and a change in the power-supply voltage, even if a constant current is supplied to the LED. To avoid this, it is preferable that a device for detecting the temperature of the LED itself, the power-supply voltage, etc. be provided beforehand, and that the above described brightness correction process be performed when the detected values vary beyond a certain range.

In the embodiment described above, a portable liquid crystal display device is dealt with; in practice, the present invention finds wide application in image display devices, such as projectors, which adopts the FS method.

The present invention may be carried out in any manner other than specifically described above as embodiments, and permits any variations and modifications within the spirit thereof.

### INDUSTRIAL APPLICABILITY

The present invention offers a technology useful for an image display device using a field sequential method.

1. An image display device comprising:
a backlight portion having as a light source a plurality of light emitting devices of different emission colors;
a display panel to display an image by adjusting transmittances at which the display panel transmits light from the backlight portion; and
a control section to control brightness of the light of the backlight portion,
the image display device configured to use a field sequential method whereby the image is displayed as a result of the light emitting devices being lit in turn, one for each field,
wherein the image display device further comprises brightness sensors arranged to face the backlight portion with the display panel in between, the brightness sensors arranged to detect, one for each of the emission colors, brightness of the light emitted from the backlight portion and transmitted through the display panel; and
wherein the control section is configured to controls, for each of the emission colors independently, the brightness of the light of the backlight portion according to values of the detected brightness.

2. The image display device of claim 1 including
a detection window in a part of the display panel, wherein the light is transmitted through the detection window at fixed transmittances no matter which field; and
wherein the brightness sensors are arranged to detect the brightness of the light transmitted through the detection window.

3. An image display device, comprising:
a backlight portion having as a light source a plurality of light emitting devices of different emission colors;
a display panel to display an image by adjusting transmittances at which the display panel transmits light from the backlight portion; and
a control section to control brightness of the light of the backlight portion,
the image display device configured to use a field sequential method whereby the image is displayed as a result of the light emitting devices being lit in turn, for each field,
wherein the image display device further comprises a brightness sensor to detect the brightness of the light from the backlight portion for each of the emission colors independently and to sense the brightness with a light-receiving portion shared for the different emission colors; and
wherein the control section is configured to control, for each of the emission colors independently, the brightness of the light of the backlight portion according to values of the detected brightness.

4. The image display device of claim 1 or 2,
wherein the brightness sensor is arranged to sense the brightness with a shared light-receiving portion no matter which emission color.

5. The image display device of claim 1 or 2 further comprising:
a calculation section to calculate, for each of the emission colors independently, a difference between a value of the detected brightness and a value of a predetermined target brightness,
wherein the control section is configured to controls the brightness of the light of the backlight portion so as to minimize an absolute value of the difference.

6. The image display device of claim 1 or 2, wherein the light emitting devices are operable to emit light having brightness corresponding to amounts of current supplied respectively thereto; and
the control section is configured to control the brightness of the light from the backlight portion by controlling the amounts of current supplied to the light emitting devices.

7. The image display device of claim 6,
wherein the control section is configured to control the amount of current using at least one a PWM method or a variable constant current circuit.
